(19) United States
(12) Patent Application Publication
(10) Pub. No.: US 2003/0058534 A1
(43) Pub. Date: Mar. 27, 2003

(54) Optical system having extremely low polarization dependent loss and polarization mode dispersion

(76) Inventors: Bradley A. Scott, Silverado, CA (US); John P. Kondis, Costa Mesa, CA (US)

Correspondence Address: Price, Heneveld, Cooper,, DeWitt & Litton, 695 Kenmoor, S.E., Post Office Box 2567, Grand Rapids, MI, 49501, US

(21) Appl. No.: 10/121,438

(22) Filed: Apr. 12, 2002

Related U.S. Application Data
(60) Provisional application No. 60/283,593, filed on Apr. 13, 2001.

(51) Int. Cl. G02B 5/30; G02B 27/28

(52) U.S. Cl. 359/488

(57) ABSTRACT

An optical system of the present invention includes a polarization beam separator for receiving an input beam and separating the input beam into a first component that propagates along a first path and a second component a polarization opposite that of the first component, the second component being directed along a second path spatially separated from the first path, a polarization changer provided in the first path for changing the polarization of the first component to the same polarization as the second component, a redirecting optical subsystem for receiving the first and second components and redirecting the first component back in superposition along the second path and the second component back in superposition along the first path, and a polarization beam combiner for combining the redirected first and second components to provide an output beam.

### CROSS-REFERENCE TO RELATED APPLICATIONS

This application claims the benefit of priority under 35 U.S.C. §119(e) for U.S. Provisional Patent Application No. 60/283,593 entitled “OPTICAL SYSTEM HAVING EXTREMELY LOW POLARIZATION DEPENDENT LOSS AND POLARIZATION MODE DISPERSION” filed on Apr. 13, 2001, by John P. Kondis et al., the entire disclosure of which is incorporated herein by reference.

### BACKGROUND OF THE INVENTION

1. Field of the Invention

The present invention relates to optical systems.

2. Technical Background

In the past two decades, fiberoptics have transformed the telecommunications marketplace. Initially, network designs included relatively low speed transceiver electronics at each end of the communications link. Light signals were switched by being converted into electrical signals, switched electronically, and reconverted into light signals. The bandwidth of electronic switching equipment is limited to about 10 GHz. On the other hand, the bandwidth of single mode optical fibers in the 1550 nm region of the electromagnetic spectrum is in the Terahertz range. As the demand for bandwidth increases exponentially, network designers have sought ways to exploit the available bandwidth in the 1550 nm region.

Polarization dependent loss (PDL) and polarization mode dispersion (PMD) can severely degrade the quality of optical networking signals. As optical networking systems move to very high data rates, such as 10 Gbit/s and 40 Gbit/s, PDL and PMD become even more important. Therefore, optical systems and components with very low PMD and PDL are extremely valuable.

### SUMMARY OF THE INVENTION

According to an embodiment of the present invention, an optical system comprises: a polarization beam separator for receiving an input beam and separating the input beam into a first component that propagates along a first path and a second component a polarization opposite that of the first component, the second component being directed along a second path spatially separated from the first path; a polarization changer provided in the first path for changing the polarization of the first component to the same polarization as the second component; a redirecting optical subsystem for receiving the first and second components and redirecting the first component back in superposition along the second path and the second component back in superposition along the first path; and a polarization beam combiner for combining the redirected first and second components to provide an output beam.

According to another embodiment of the present invention, a method of reducing polarization dependent losses in an optical system comprises the steps of: separating an input beam into two orthogonally polarized beamlets propagating along spatially separated incoming paths; and redirecting the beamlets such that an outgoing path for each polarized beamlet is superimposed on the incoming path for the other polarized beamlet.

According to another embodiment of the present invention, a method of reducing polarization mode dispersion in an optical system comprises: separating an input beam into two orthogonally polarized beamlets propagating along spatially separated incoming paths; and redirecting the beamlets such that an outgoing path for each polarized beamlet is superimposed on the incoming path for the other polarized beamlet.

According to another embodiment of the present invention, an optical system comprises: a polarization beam separator/combiner for receiving an input beam and separating the input beam into two orthogonally polarized first and second beamlets propagating along spatially separated incoming paths; a polarization changer for changing the polarization of the first beamlet to the same polarization as the second beamlet; and a reflective optical subsystem for receiving the beamlets and reflecting the beamlets such that an outgoing path for each polarized beamlet is superimposed on the incoming path for the other polarized beamlet. The reflected second beamlet impinges upon the polarization changer, which changes the polarization of the reflected second beamlet to a polarization orthogonal that of the reflected first beamlet. The reflected first and second beamlets then impinge upon the polarization beam separator/combiner, which combines the reflected first and second components to provide an output beam.

Additional features and advantages of the invention will be set forth in the detailed description which follows and will be apparent to those skilled in the art from the description or recognized by practicing the invention as described in the description which follows together with the claims and appended drawings.

It is to be understood that the foregoing description is exemplary of the invention only and is intended to provide an overview for the understanding of the nature and character of the invention as it is defined by the claims. The accompanying drawings are included to provide a further understanding of the invention and are incorporated and constitute part of this specification. The drawings illustrate various features and embodiments of the invention which, together with their description serve to explain the principals and operation of the invention.

### BRIEF DESCRIPTION OF THE DRAWINGS

In the drawings:

FIG. 1 is a diagram of an optical system constructed in accordance with the present invention;

FIG. 2 is a diagram of a dynamic spectral equalizer employing the optical system of the present invention;

FIG. 3 is a side view of a portion of the dynamic spectral equalizer shown in FIG. 2; and

FIG. 4 is a diagram of dual dynamic spectral equalizer/wavelength selective switch utilizing the optical system of the present invention.

### DETAILED DESCRIPTION OF THE PREFERRED EMBODIMENT

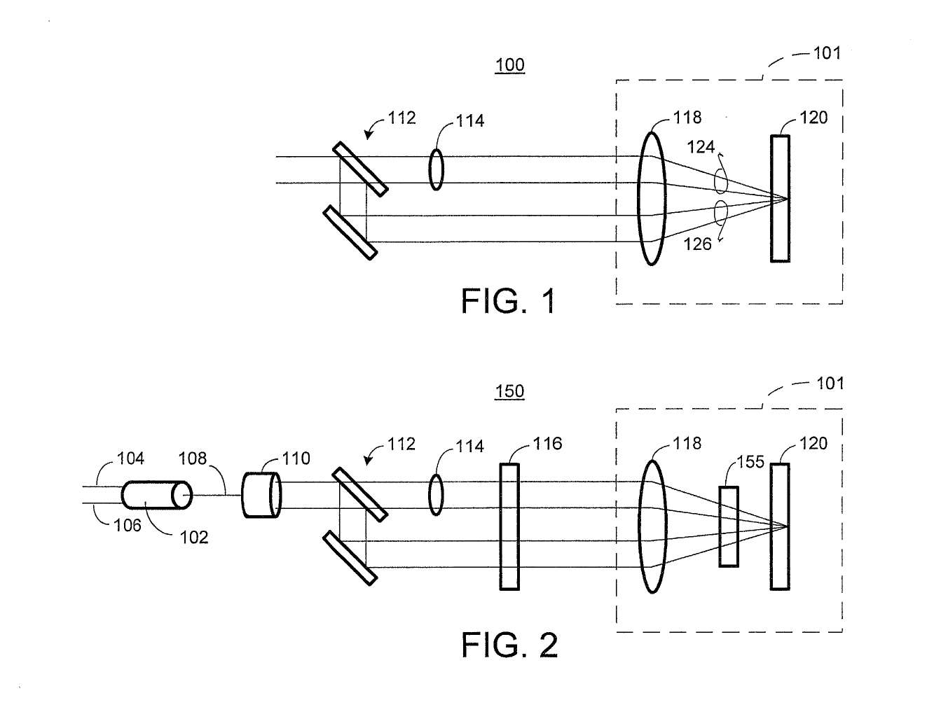

The optical system of the present invention is shown in FIG. 1. The depicted optical system 100 includes a polarization beam separator/combiner 112, which separates the input light beam into a first beamlet that propagates along a first path and an orthogonally polarized second beamlet that is directed along a second path spatially separated from the first path. Optical system 100 also includes a polarization changer (i.e., a polarizer or retarder) 114 provided in the first path of the first beamlet so as to change the polarization of that beamlet to be the same as the second beamlet. Optical system 100 further includes a redirecting optical subsystem 101 is provided for receiving the first and second beamlets and redirecting the first beamlet back in superposition along the second path and the second beamlet back in superposition along the first path. Polarization beam separator/combiner 112 the combines the redirected first and second beamlets to provide an output beam.

Redirecting optical subsystem 101 may include a lens 118 and a redirecting element 120, which is preferably a reflective element, provided at the focus of lens 118. In the most simple construction, redirecting element 120 is a mirror. In more complex applications, redirecting optical subsystem 101 may include a reflective liquid crystal (LC) device, a MEMs array, a corner cube, a system of two or more mirrors that appropriately arranged, and a system of appropriately arranged prisms. In general, the redirecting optical subsystem 101 has the following properties: (1) its output is redirected toward the input of an optical system such as that shown in FIG. 1 in such a manner that the input and output of the optical system are superimposed; and (2) the incoming path for each polarization is largely superimposed on the outgoing path for the other polarization.

Although the redirecting optical subsystem 101 is described herein as being reflective, it will be appreciated by those skilled in the art that redirecting subsystem 101 also may include non-reflective components that redirect light via diffraction or refraction. It will also be noted that some reflective subsystems do not have both the properties noted above.

By splitting the input beam into two polarization components that travel the identical paths but in opposite directions, PDL and PMD are extremely low because optical effects that cause loss, phase shift, and time delay typically are not dependent on propagation direction. Because the input beam and output beam are substantially superimposed, in practice, it is usually desirable to provide some means to separate the outgoing beam from the input beam. The device used to access the output beam typically has PDL and PMD that are much larger than the optical system shown in FIG. 1 and its derivatives. In practice, the PDL and PMD introduced by the optical system are typically so low as to be unmeasurable.

FIG. 2 shows an example of the addition of means for separating the output beam from the input beam. As shown in FIG. 2, the optical system may further include a circulator 102 coupled to an input fiber 104, an output fiber 106, and a common fiber 108. Input fiber 104 supplies an input light beam to circulator 102, which outputs this input beam on common fiber 108 with substantially no leakage to output fiber 106. As will be described further below, light beams propagate in both directions through common fiber 108. Light beams that circulator 102 receives via common fiber 108 are output by circulator 102 on output fiber 106 with substantially no leakage to input fiber 104. A lens 110 is provided at the opposite end of common fiber 108 from circulator 102. Lens 110 collimates the input light beam supplied from common fiber 108 while focusing collimated beams it receives from its opposite direction from and coupling such beams into common fiber 108 for transmission to circulator 102. The collimated input beam received by polarization beam separator/combiner 112 is provided from lens 110. Likewise, lens 110 focuses the collimated output beam output from polarization beam separator/combiner 112 and couples the output beam into common fiber 108.

Polarization beam separator/combiner 112 is shown as a pair of beam polarizing beamsplitters, however other polarization beam separators/combiners including, but not limited to, birefringent plates, polarizing prisms, and polarization beamsplitting slabs can be used. Polarization changer 114 may be a retarder or polarization rotator, such as a retardation plate, a crystal rotator or an LC device.

In the presently most preferred embodiment, the optical system uses Corning SMF-28 fiber as the input fiber 104, output fiber 106 and common fiber 108, a c-band optical circulator available from New Focus Part No. 11102p as the optical circulator 102, a c-band collimator available from LightPath Technologies Part No. TC2.0*6.35 as lens 110, a polarizing beamsplitting slab constructed in accordance with the teachings of commonly-assigned U.S. patent application Ser. No. 09/537,978, entitled “PARALLEL PLATE BEAMSPLITTER AND APPLICATIONS”, by Bradley Scott and filed on Mar. 28, 2000, as the polarization beam separator/combiner 112, a custom compound zero order quartz half-wave retarder optimized for operation a 1550 nm per LINOS Photonics Part No. 36 2703 257, a custom doublet lens similarly assembled at Coming GGM from custom optical components procured from LINOS Photonics and other vendors as lens 118, and a reflector with a metallic mirror coating similar to the standard products available from Melles Griot as coating type/045, as redirecting element 120. The entire disclosure of U.S. patent application Ser. No. 09/537,978 is incorporated herein by reference.

The PDL and PMD of the system described above and shown in FIG. 2 (with the exception of dispersive element 116 described below), are limited by the input fiber, output fiber, and circulator. With commercially available products, such as those disclosed above, PDL less than 0.1 dB and PMD less than 0.1 psec can be readily achieved. As will be understood from the foregoing and set forth in the following exemplary implementations, any optical component can be added to the above architecture at any point between the polarization beam separator/combiner 112 and redirecting element 120 without adding substantial PMD or PDL into the optical system.

The optical system of the present invention may be implemented in various different optical components having varying functions. Commonly assigned U.S. Provisional Patent Application No. 60/283,592, entitled “DYNAMIC SPECTRAL EQUALIZER AND WAVELENGTH SELECTIVE SWITCH HAVING EXTREMELY LOW POLARIZATION DEPENDENT LOSS AND POLARIZATION MODE DISPERSION” and filed on Apr. 13, 2001, and commonly assigned U.S. patent application No. ______ [Attorney Docket No. COR20 P412], entitled “DYNAMIC SPECTRAL EQUALIZER AND WAVELENGTH SELECTIVE SWITCH HAVING EXTREMELY LOW POLARIZATION DEPENDENT LOSS AND POLARIZATION MODE DISPERSION” and filed on even date herewith, disclose several examples of implementations utilizing the optical system of the present invention. The entire disclosures of these applications are incorporated herein by reference. A few examples are described below including a dynamic spectral equalizer (DSE), a wavelength selective switch (WSS), and a dual DSE. It will be appreciated, however, that aspects of the inventive optical system may be employed in other optical components having different functions from either a DSE or a WSS.

The optical system shown in FIG. 2 may be modified to function in a telecommunications optical system. The telecommunications optical system would receive what is hereinafter referred to as an input “composite beam.” A composite beam is composed of a plurality of “component beams” each corresponding to a different wavelength or channel. Each channel carries different information. In some situations, it is desirable to operate on the channels independently thereby necessitating that the composite beam carried over long fibers, be broken down into its component beams or beamlets. When implementing the present invention, the input composite beam is first separated into its orthogonally polarized beamlets. The first and second component beamlets thus output by polarization beam separator/combiner 112 may be broken down into respective first and second sets of component beamlets by placing a dispersive element 116 to spectrally disperse the first composite beamlet into a first set of spatially separated component beamlets and to spectrally disperse the second composite beamlet into a second set of spatially separated component beamlets. Each of the component beamlets of the first set corresponds to different communication channels of the first input composite beam as does each component beamlet of the second set. Each component beamlet in the first set has a corresponding component beamlet in the second set at the same wavelength, which together constitute a “channel pair.”

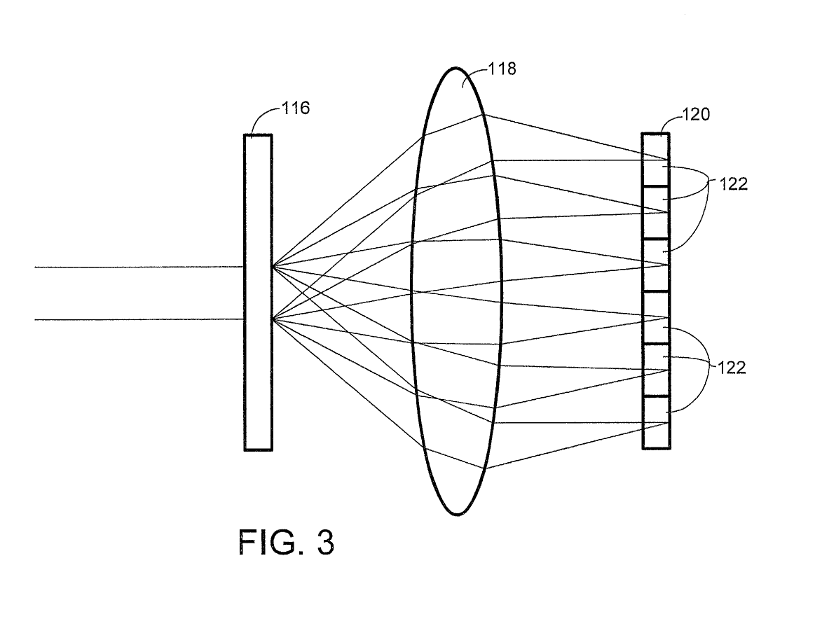

Assuming FIG. 2 is a top plan view of the optical system, FIG. 3 is a side elevational view showing the spatial separation of the component signals by dispersive element 116. It will be appreciated that the polarizations can be separated in the same plane as the dispersion of the dispersive element 116 or in a plane perpendicular to the dispersion of dispersive element 116. For purposes of example, six different component signals are illustrated. It will be appreciated, however, that the number of component signals will be dependent upon the number of channels carried by the input and output fibers. As shown in FIGS. 2 and 3, for a DSE, redirecting optical subsystem 101 includes a lens 118 that is provided for focusing each of the component beamlets onto a corresponding modulating element 122 of a reflective spatial light modulator serving as redirecting element 120. As will be described in further detail below, each modulating element 122 of reflective spatial light modulator 120 may be independently activated so as to selectively modulate each of the beamlets so that its proportional power after collection at the output fiber is at the desired value. Furthermore, the optical system is constructed such that the first set of component beamlets is focused onto a reflective surface of light modulator 120 at an angle equal to and opposite that of the second set of component beamlets. Thus, as shown in FIG. 2, the first set of component beamlets that is directed at reflective spatial light modulator 120 along a first incoming path 124 is reflected to a first outgoing path that is superimposed upon a second incoming path 126 for the second set of component beamlets. Likewise, the second set of component beamlets is reflected by reflective spatial light modulator 120 to a second outgoing path superimposed upon the first incoming path 124. The reflected first and second sets of component beamlets are then collimated by lens 118 and directed back to dispersive element 116, which recombines each set of reflected component beamlets into first and second reflected composite beamlets. Polarization changer 114 then changes the polarization of one of the reflected composite beamlets such that the two reflected composite beamlets are orthogonally polarized with respect to one another. Polarization beam separator/combiner 112 then combines the two reflected composite beamlets and it directs the superimposed beamlets to lens 110, which couples the resultant output composite beam to common fiber 108, which in turn, supplies the output composite beam to circulator 102, which outputs the output composite beam on output fiber 106.

Polarization beam separator/combiner 112 may be a pair of beam polarizing beamsplitters. Alternatively, other polarization beam separators may be utilized including, but not limited to, birefringent plates, polarizing prisms, and polarization beamsplitting slabs. The polarization changer 114 may be, but is not limited to, a retardation plate, a crystal rotator, or a liquid crystal. Dispersive element 116 may be, but is not limited to, a grating, prism, or grism. Reflective spatial light modulator 120 may be, but is not limited to, reflective liquid crystal displays, pixellated birefringent crystal arrays, MEMs devices, and arrays of variable filters. Preferably, reflective spatial light modulator 120 is a reflective LC device constructed as disclosed in commonly assigned U.S. Provisional Patent Application Nos. 60/283,592 entitled “DYNAMIC SPECTRAL EQUALIZER AND WAVELENGTH SELECTIVE SWITCH HAVING EXTREMELY LOW POLARIZATION DEPENDENT LOSS AND POLARIZATION MODE DISPERSION,” filed on Apr. 13, 2001, and 60/283,756 entitled “______” and filed on Apr. 13, 2001, and in commonly assigned U.S. patent application Ser. Nos. ______ [Attorney Docket No. COR20 P413], entitled “HIGH CONTRAST REFLECTIVE LCD FOR TELECOMMUNICATIONS APPLICATIONS” and filed on even date herewith, and ______[Attorney Docket No. COR20 P412], entitled “DYNAMIC SPECTRAL EQUALIZER AND WAVELENGTH SELECTIVE SWITCH HAVING EXTREMELY LOW POLARIZATION DEPENDENT LOSS AND POLARIZATION MODE DISPERSION” and filed on even date herewith, the entire disclosures of each of these applications are incorporated herein by reference.

For many applications, it is desirable to have a DSE that can achieve very high extinction blocking (e.g., 35 dB or higher), so that it can block portions of the optical spectrum to a high degree. In practice, limitations on the quality of the components available for the approach illustrated in FIG. 2 may prevent achieving very high extinction when reflective polarization modulators are used as the reflective spatial light modulator 120. A high extinction, extremely low polarization dependent DSE can be attained by providing an additional polarizer 155 between lens 118 and reflective spatial light modulator 120. It should be noted that polarizer 155 can be placed anywhere between polarization changer 114 and reflective spatial light modulator 120. Polarizer 155 serves to increase the polarization purity of the input beam to reflective spatial light modulator 120 and to improve the polarization filtering of the output beam from reflective spatial light modulator 120. Polarizer 155 can be, but is not limited to, a polarizing prism, a polymer linear polarizer, a polarcor linear polarizer, or one or more Brewster plates.

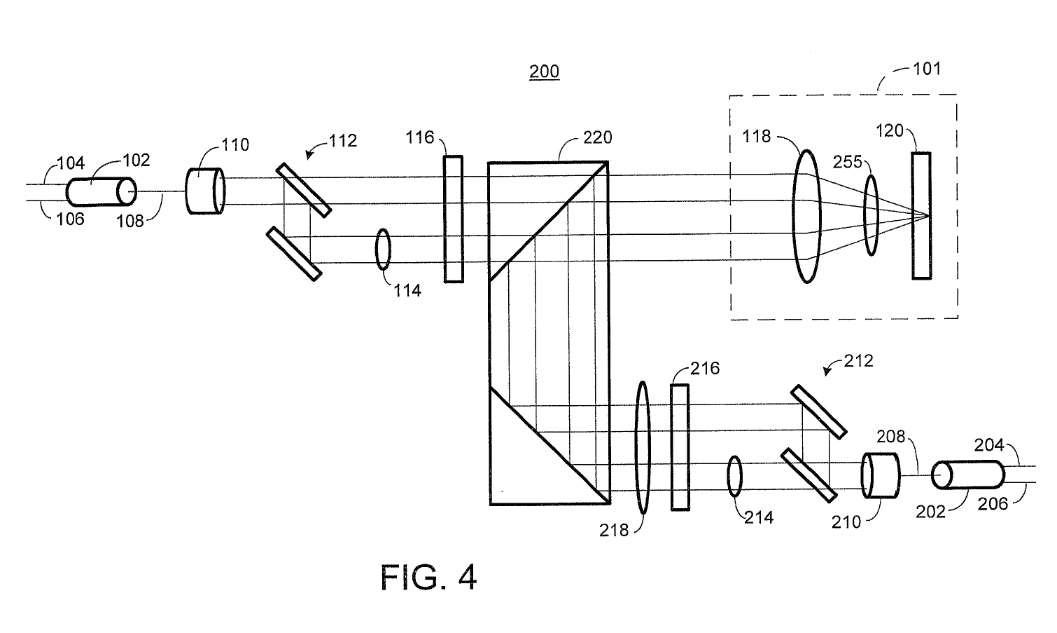

The optical system shown in FIGS. 2 and 3 may be readily converted into a WSS by adding the additional components shown in FIG. 4, which shows an optical system 200 according to a third embodiment of the present invention. Specifically, a second circulator 202 may be added that is coupled to a second input fiber 204, a second output fiber 206, and a second common fiber 208. Similarly, a second lens 210 may be provided between the output of second common fiber 208 and a second polarization beam separator 212. Second circulator 202, second lens 210, and second polarization beam separator 212 may be constructed in an identical fashion to first circulator 102, first lens 110, and first polarization beam separator 112, respectively. Thus, second polarization beam separator 212 separates a second input composite beam received from second input fiber 204 into spatially separated, orthogonally polarized third and fourth composite beamlets.

A second polarization changer 214 is provided in the path of one of the third and fourth composite beamlets so as to change its polarization to be identical to that of the other of these two composite beamlets. A second dispersive element 216 similar to first dispersive element 116 is positioned so as to disperse the third and fourth composite beamlets into respective third and fourth sets of component beamlets.

Unlike the structure shown in FIG. 2, a third polarization changer 218 is provided in the paths of all of the third and fourth sets of component beamlets so as to change the polarization of the beamlets from the second input fiber 204 to have the opposite polarization of those from the first input fiber 104. The oppositely polarized component beamlets from the first and second input fibers are then combined by a polarization beam combiner 220 such that the first set of component beamlets is superimposed with the third set of component beamlets and the second and fourth sets of component beamlets are superimposed upon one another, and then all the beamlet sets are directed at lens 118 in a manner similar to that described above with respect to FIGS. 2 and 3. Lens 118 focuses the sets of beamlets onto a corresponding modulating element 122 of reflective spatial light modulator 120. The first and third sets of component beamlets are directed at their corresponding modulating element 122 along a first incoming path 124 at an angle relative to the reflective surface of reflective spatial light modulator 120 so as to have an outgoing path that is superimposed upon the second incoming path 126 of the second and fourth sets of component beamlets. Likewise, the second and fourth sets of component beamlets have an outgoing path that is superimposed on the incoming path 124 of the first and third sets of component beamlets. The outgoing reflected component beamlets are then collimated by lens 118 and subsequently separated by beam polarization combiner 220.

When the optical system 200 shown in FIG. 4 and described above is configured to operate as a WSS, a first input composite beam entering system 200 on first input fiber 104 passes from the first input fiber to circulator 102, which in turn passes the beam to common fiber 108 without substantial leakage into output fiber 106. The first input composite beam on common fiber 108 is then substantially collimated by lens 110 and is then separated by first polarization beam separator 112 into orthogonally polarized first and second composite beamlets. First polarization changer 114 changes the polarization of the second composite beamlet to be the same as the first composite beamlet. The first and second composite beamlets are then incident on dispersive element 116, which outputs first and second sets of component beamlets whose propagation direction is dependent on their wavelength. These first and second component beamlets pass through polarization beam combiner 220 and are focussed by lens 118 such that they are separated spatially at reflective spatial light modulator 120 and such that their focus is substantially coincidental with the reflective surface of reflective spatial light modulator 120. As noted above, the system is configured such that the first set of component beamlets is directed at reflective spatial light modulator 120 along a first incoming path 124 such that they exit reflective spatial light modulator 120 along a first outgoing path that is superimposed along the second incoming path 126 of the second set of component beamlets. Likewise, the second set of component beamlets exit reflective spatial light modulator along a second outgoing path that is superimposed on the first incoming path 124 of the first set of component beamlets. The sets of component beamlets pass through the lens 118 again and are redirected toward polarization beam combiner 220.

For a WSS, reflective spatial light modulator 120 is preferably a reflective polarization modulator. Thus, each modulating element 122 may be selectively activated (or deactivated) to rotate the polarization of the corresponding incident component beamlets. When deactivated (or activated), the polarization state of the incident beamlets remains the same. Because there is one modulating element 122 provided for each channel (i.e., wavelength), and hence for each pair of component beamlets from the first and second sets, each channel may be selectively and independently affected by relective spatial light modulator 120.

For those component beamlets originating from first input fiber 104 that leave reflective spatial light modulator 120 with the same polarization, the beamlets pass through polarization beam combiner 220 toward first dispersing element 116 and ultimately toward first output fiber 106. However, for those component beamlets whose polarization was rotated by a modulating element 122 of reflective spatial light modulator 120, polarization beam combiner 220 redirects those component beamlets toward third polarization changer 218, dispersive element 216, and ultimately to second output fiber 206. Each dispersive element 116 and 216 recombines the two incident sets of component beamlets into two composite beamlets. The first and second polarization changers then rotate the polarization of one of the two component beamlets so that they are orthogonally polarized and the first and second polarization beam separators 112 and 212 combine the two orthogonally polarized beamlets to form a single output composite beam. The lenses 110 and 210 then focus the output composite beam so as to couple the beam into common fibers 108 and 208. The circulators 102 and 202 then direct the output composite beam toward the first output fiber or the second output fiber, respectively, without substantial leakage to the input fibers.

As will be apparent to those skilled in the art, a second input composite beam on second input fiber 204 passes through the elements described above and is separated into third and fourth sets of component beamlets prior to being redirected by beam polarization combiner 220. For a WSS, the first and third sets of component beamlets are superimposed upon one another exactly when incident upon reflective spatial light modulator 120. Likewise, the second and fourth sets of component beamlets are superimposed. Thus, for a given wavelength channel, when the corresponding modulating element 122 does not rotate the polarization of the incident beamlets, the beamlet originating from first input fiber 104 exits the optical system on first output fiber 106 and the beamlet originating from second input fiber 204 exits second output fiber 206. However, when the corresponding modulating element 122 rotates the polarization of the incident beamlets, the beamlet originating from first input fiber 104 exits the optical system on second output fiber 206 and the beamlet at the corresponding wavelength that originates on second input fiber 204 exits the system on first output fiber 106. Thus, each channel carried on the input fibers may be independently switched.

The optical system 200 may be modified in a number of different ways so as to perform the function of a dual DSE. In such a dual DSE, the reflective spatial light modulator could still be a reflective polarization modulator, however, it may be tuned to an intermediate value or may be replaced by a spatial light modulator that combines polarization modulation capabilities with some other capability including, but not limited to, variable attenuation, variable misalignment, and variable wavefront error. In such a system, the input beams on first input fiber 104 would always exit first output fiber 106 unless they were effectively extinguished by reflective spatial light modulator 120. Similarly, second input beams on second input fiber 204 would always be output on second output fiber 206 unless effectively extinguished.

Another way to create a dual DSE using optical system 200 shown in FIG. 4 would be to align lenses 110 and 210 such that the beams that originated from input fibers 104 and 204 are not substantially superimposed at reflective spatial light modulator 120. This allows the two inputs to be modulated independently and reduces to near zero the effect of discarded power from the attenuation of one input on the signal to noise ratio of the signal from the other input. For such a dual DSE, the reflective spatial light modulator can be any reflective spatial light modulator that enables variable attenuation, variable misalignment, variable introduction of wavefront error, polarization modulation, or any other effect that will allow the intensity of the light that reaches the output fibers to be attenuated. Examples of such reflective spatial light modulators include, but are not limited to, reflective liquid crystal devices, pixellated birefringent crystal arrays, MEMs devices, and arrays of variable filters.

Polarization beam combiner 220 may be a polarizing beam-combining prism such as that depicted in FIG. 4. For ease of presentation, the depicted polarizing beam-combining prism has been illustrated as producing a spatial offset and a 180° direction change for incoming beamlets that originated from second input fiber 204. In practice, any polarization beam combiner that produces a spatial or angular offset that is sufficient to allow the incoming beams from the first and second input fibers to be superimposed onto each other can be used for this purpose. Such polarization beam combiners include, but are not limited to, birefringent plates, polarizing prisms, and polarization beamsplitting slabs. For some polarization modulators, it may be desirable that the incoming beamlets all share substantially the same sets of orthogonal polarizations. In these cases, it may be advantageous that the surface normal of the polarizing surface of the polarization beam-combining prism be substantially parallel to the plane of dispersion of the dispersive elements.

When reflective spatial light modulators are utilized that have an interface between a birefringent material and a non-birefringent material at or near the reflection plane, this interface causes a back reflection that has a component that is orthogonal to the back reflections from all interfaces between non-birefringent materials. Extinction may often be limited by this orthogonal component.

A high extinction, extremely low polarization dependent WSS or dual DSE 200 can be attained by providing an additional retarder 255 disposed between lens 118 and reflective spatial light modulator 120. When the value of additional retarder 255 between lens 118 and reflective spatial light modulator 120 is nearly, but not exactly, one-quarter wave for the wavelengths used in the device, the voltage of the reflective spatial light modulator (particularly when implemented with a liquid crystal device) can be tuned in such a way that the component of the back reflection off of the birefringent interfaces that is orthogonal to all other back reflections can be substantially eliminated. Additionally, because retarder 255 is nearly one-quarter wave, all other back reflections for the output that return to the fiber from which it was received are substantially eliminated by the retarder 255. In practice, this method of compensation enables isolation of substantially greater than 40 dB to be consistently achieved. It should be noted that additional retarder 255 can also be disposed between lens 118 and polarization beam combiner 220 to achieve the same result. It is also noted that additional retarder 255 can be used in the single DSE embodiment shown in FIG. 2 to improve its isolation to substantially greater than 40 dB.

Although specific implementations of the inventive optical system and methods are described above, those skilled in the art will recognize that application of the inventive optical system and method are not limited to those specific examples and may be implemented in different forms of DSEs, WSSs or other optical components with different functions.

It will become apparent to those skilled in the art that various modifications to the preferred embodiment of the invention as described herein can be made without departing from the spirit or scope of the invention as defined by the appended claims.

The invention claimed is:

1. An optical system comprising:
a polarization beam separator for receiving an input beam and separating the input beam into a first component that propagates along a first path and a second component a polarization opposite that of the first component, the second component being directed along a second path spatially separated from the first path;
a polarization changer provided in the first path for changing the polarization of the first component to the same polarization as the second component;
a redirecting optical subsystem for receiving the first and second components and redirecting the first component back in superposition along the second path and the second component back in superposition along the first path; and
a polarization beam combiner for combining the redirected first and second components to provide an output beam.

2. The optical system of claim 1, wherein the redirected first and second components impinge upon said polarization beam separator, which functions as said polarization beam combiner.

3. The optical system of claim 2, wherein the redirected second component impinges upon said polarization changer, which changes the polarization of the second component to a polarization opposite the first component, the redirected first and second components then impinge upon said polarization beam separator/combiner, which combines the redirected first and second components to provide an output beam.

4. The optical system of claim 1, wherein said redirecting optical subsystem comprises a reflective element and a lens for receiving both the first and second components and focusing the components on said reflective element, the first component reflecting from said reflective element along the second path and the second component reflecting from said reflective element along the first path, said lens receiving the reflected first and second components and collimating the components.

5. The optical system of claim 4, wherein said reflective element is a mirror.

6. The optical system of claim 5, wherein said mirror is positioned proximate a focal plane of said lens.

7. The optical system of claim 1, wherein said polarization beam separator comprises a polarization splitter for separating the first and second components, and a mirror for redirecting the second component in the second path.

8. The optical system of claim 7, wherein, between said polarization beam separator and said redirecting optical subsystem, the second path is parallel to the first path.

9. The optical system of claim 1, wherein, between said polarization beam separator said the redirecting optical subsystem, the second path is parallel to the first path.

10. The optical system of claim 1, wherein the input beam is collimated and the first and second components output from said polarization beam separator and said polarization changer are collimated.

11. The optical system of claim 1, wherein said polarization changer is a polarization rotator.

12. The optical system of claim 1, wherein said polarization changer is a retarder plate.

13. The optical system of claim 1, wherein said polarization beam combiner superimposes the output beam on the input beam.

14. The optical system of claim 1 and further comprising a common optical fiber for guiding the input beam towards said polarization beam separator, and for receiving the output beam from said polarization beam combiner.

15. The optical system of claim 14 and further comprising a lens disposed between one end of said common fiber and said polarization beam separator, said lens receives the input beam from said common fiber and collimates the input beam.

16. The optical system of claim 15, wherein said lens further receives the output beam from said polarization beam combiner and couples the output beam into said common fiber.

17. The optical system of claim 14 and further comprising an input optical fiber, an output optical fiber, and a circulator coupled to said input, output and common fibers, said circulator receives the input beam from said input fiber and directs the input beam to said common fiber, said circulator further receiving the output beam from said common fiber and directs the output beam to said output fiber.

18. A method of reducing polarization dependent losses in an optical system comprising the steps of:
separating an input beam into two orthogonally polarized beamlets propagating along spatially separated incoming paths; and
redirecting the beamlets such that an outgoing path for each polarized beamlet is superimposed on the incoming path for the other polarized beamlet.

19. The method of claim 18 and further comprising the step of recombining the beamlets to provide an output beam.

20. The method of claim 19 and further comprising the step of superimposing the output beam on the input beam.

21. The method of claim 18 and further comprising the step of changing the polarization of one beamlet to be the same as that of the other beamlet prior to the redirecting step.

22. The method of claim 18 and further comprising the step of changing the polarization of one beamlet to be the same as that of the other beamlet after the redirecting step.

23. The method of claim 22 and further comprising the step of recombining the beamlets after changing the polarization of one of the beamlets to provide an output beam.

24. A method of reducing polarization mode dispersion in an optical system comprising:
separating an input beam into two orthogonally polarized beamlets propagating along spatially separated incoming paths; and
redirecting the beamlets such that an outgoing path for each polarized beamlet is superimposed on the incoming path for the other polarized beamlet.

25. An optical system comprising:
a polarization beam separator/combiner for receiving an input beam and separating the input beam into two orthogonally polarized first and second beamlets propagating along spatially separated incoming paths;
a polarization changer for changing the polarization of the first beamlet to the same polarization as the second beamlet; and
a reflective optical subsystem for receiving the beamlets and reflecting the beamlets such that an outgoing path for each polarized beamlet is superimposed on the incoming path for the other polarized beamlet,
wherein the reflected second beamlet impinges upon said polarization changer, which changes the polarization of the reflected second beamlet to a polarization orthogonal that of the reflected first beamlet, the reflected first and second beamlets then impinge upon said polarization beam separator/combiner, which combines the reflected first and second components to provide an output beam.

26. The optical system of claim 25, wherein said reflecting optical subsystem comprises a reflective element and a lens for receiving both the first and second beamlets and focusing the components on said reflective element, the first beamlet reflecting from said reflective element along the second path and the second beamlet reflecting from said reflective element along the first path, said lens receiving the reflected first and second beamlets and collimating the beamlets.

27. The optical system of claim 26, wherein said reflective element is a mirror.

28. The optical system of claim 27, wherein said mirror is positioned proximate a focal plane of said lens.

29. The optical system of claim 25, wherein said polarization beam separator/combiner comprising a polarization splitter for separating the first and second beamlets, and a mirror for redirecting the second beamlet in the second path.

30. The optical system of claim 29, wherein, between said polarization beam separator/combiner and said reflecting optical subsystem, the second path is parallel to the first path.

31. The optical system of claim 25, wherein the input beam is collimated and the first and second beamlets output from said polarization beam separator/combiner and said polarization changer are collimated.

32. The optical system of claim 25, wherein said polarization beam separator/combiner superimposes the output beam on the input beam.

33. The optical system of claim 25 and further comprising a common optical fiber for guiding the input beam towards said polarization beam separator/combiner, and for receiving the output beam from said polarization beam separator/combiner.

34. The optical system of claim 33 and further comprising a lens disposed between one end of said common fiber and said polarization beam separator/combiner, said lens receives the input beam from said common fiber and collimates the input beam, said lens further receives the output beam from said polarization beam separator/combiner and couples the output beam into said common fiber.

35. The optical system of claim 34 and further comprising an input optical fiber, an output optical fiber, and a circulator coupled to said input, output and common fibers, said circulator receives the input beam from said input fiber and directs the input beam to said common fiber, said circulator further receiving the output beam from said common fiber and directs the output beam to said output fiber.
